(19) United States
(12) Patent Application Publication
(10) Pub. No.: US 2009/0076988 A1
(43) Pub. Date: Mar. 19, 2009

(54) Method and system for optimal choice

(76) Inventor: Evan J. Stanelle, Middleton, WI (US)

Correspondence Address: Paul E. Schaafsma;NovusIP, LLC, Suite 221, 521 West Superior Street, Chicago, IL, 60610-3135, US

(21) Appl. No.: 11/706,930

(22) Filed: Feb. 14, 2007

(51) Int. Cl. G06F 15/18; G06N 5/02; G06F 17/00

(52) U.S. Cl. 706/12; 706/47

(57) ABSTRACT

A method and system for optimal choice is described. An inductive database system uses an integration of historical data and virtual data (in the form of intuitive rule-sets specified by an agent or plurality of agents) to make statistical recommendations for optimal choice. Filter mechanisms support the reporting of choice recommendations and user interaction with historical data. In the latter case, user interaction with a deductive interface allows for the testing of decision criteria or rule-sets against an historical database and empirical target results. The constant testing of ideas against an objective function provides an update methodology for a database of virtual data and provides a training methodology for the user. An example of picking stock investments is given.

### FIELD OF THE INVENTION

This invention pertains generally to systems and methods facilitating the decision making of a decision making agent.

### BACKGROUND OF THE INVENTION

Decision making is a computationally complex process. Decision making involves generating, evaluating, and selecting from an infinitely large set of alternatives. A stock purchase, for example, is a computationally complex decision problem. An investor may want to know the potential return and risk as well as the fundamental and technical attributes and stock price for each company before making an investment decision. But given the vast and unlimited information to consider for each alternative, the investor would need an infinite amount of time to make an objectively optimal choice.

To cope with the computational complexity of a decision problem, research on decision making has shown that humans reliably adopt cognitive heuristics (i.e., strategies) to simplify the problem space of alternatives. An investor, for example, may invest in the first stock that meets his or her investment criteria rather than taking the time to evaluate every alternative. Using a heuristic limits the space of alternatives, saves time, and ensures that the alternative selected satisfies the goal. Consequently, instead of making optimal decisions all of the time, humans are said to make good decisions most of the time.

In most cases, trading a degree of optimality for a degree of efficiency in a decision task is acceptable. Mundane examples include taking the first open parking space in a crowded lot or selecting the closest box of cereal within your reach. On the other hand, this trade-off can be grossly inefficient when an objective is to be optimized, since suboptimal choice may actually lead to loss. Possible instances include buying the first stock that has attribute A<X, hiring the first person with attribute B or going to war when C looks like D. A more careful consideration of the evidence is needed when optimizing an objective function. And given the cognitive limitations to optimization—humans cannot know all the relevant alternatives, cannot know the probability outcome for each alternative, and have insufficient memories—a suitable technology or process would be beneficial.

One such attempted solution has taken shape through the emergence of database technologies and information search. By organizing the billions of documents that make up the World Wide Web into a list of choice alternatives, information search has taken a broad step toward a process of optimal choice. Virtual memory and page ranking algorithms help overcome human limitations for generating alternatives, thus limiting the computational complexity of a decision problem. Moreover, online interfaces allow for the immediate testing of alternatives and the evaluation of outcome results. The sheer explosion of information management technologies, online information service providers, and the profitability of large search engines demonstrate the high demand for such efficiency.

The outstanding challenge to the process of information search and to the decision makers who use it, is how to make database systems like the World Wide Web more intelligent. Because an exhaustive list of alternatives is still computationally complex, a level of meaning is necessary to make the tasks of evaluation and selection more optimal. An investor using the term stock recommendation in a Google search, located at www.google.com and made available by Google Inc., 1600 Amphitheatre Parkway, Mountain View, Calif. 94043, for example, will have over 8 million documents to consider. And in most cases, a document link will lead to a page of information requiring a parallel degree of computational complexity for choosing what points of information are relevant to the decision task at hand. Experts generally agree that a system that can maintain the efficiency of information search with an improved process for optimal choice would become more commercially valuable than today's search engines. (Markoff, J. “Could the future bring the Internet as your personal adviser?” The New York Times, Sunday, 12 Nov. 2006). A key challenge is how to overlay user meaning to a set of choice alternatives without the cognitive biases that prevent optimal choice.

Although there are no known prior art teachings for a process of optimal choice, several prior art references bear relation to matters discussed herein. U.S. Pat. No. 4,829,426 to Cogensys Corporation discloses a system and method for logically modeling the decision making process of an expert. The solution overcomes limitations of traditional systems that do not “learn” directly from the interaction with the expert. Though this patent discloses a method for improving a computer-generated model of decision making, it does not teach or suggest a process that overcomes or accounts for the cognitive biases of a decision making agent that occur when making an objectively optimal choice.

U.S. Pat. No. 5,182,793 to Texas Instruments Incorporated discloses a method for assisting persons in decision making. Using symbolic knowledge, the method provides multiple representations of choice alternatives relevant to agent input to help select the best choice among alternatives in a particular domain. Though the method helps mitigate the memory limitations of a decision maker, this patent does not teach or suggest a process that overcomes or accounts for the cognitive biases of a decision making agent that occur when making an objectively optimal choice.

U.S. Pat. No. 5,704,017 to Microsoft Corporation discloses a system utilizing a belief network, or Bayesian network, to combine empirical attribute data with prior expert knowledge to make preference recommendations upon user input. Though this patent suggests a method for predicting the preferences of an agent given certain agent attributes, it does not teach or suggest a process that overcomes or accounts for the cognitive biases of a decision making agent that occur when making an objectively optimal choice.

U.S. Pat. No. 5,862,364 to IBM Corporation discloses a system and method for graphically generating states of a decision making model. The storage and graphical representation of a complex decision model having multiple inputs helps overcome the memory limitations of a human decision maker. However, this patent does not teach or suggest a process that overcomes or accounts for the cognitive biases of a decision making agent that occur when making an objectively optimal choice.

U.S. Pat. No. 5,878,214 to Synectic Corporation discloses a process and apparatus that polls a plurality of decision makers about solutions to a specific problem. The collaborative approach helps organize multiple agents, thus mitigating the cognitive bias inherent to a polled result. However, this patent does not teach or suggest a process that overcomes or accounts for the cognitive biases of a decision making agent that occur when making an objectively optimal choice.

U.S. Pat. No. 6,119,149 to i2 Technologies, Inc. discloses a process for optimal decision making using a method of enterprise, workflow collaboration. The collaborative approach, like U.S. Pat. No. 5,878,214, helps organize multiple agents for problem solving and decision making, thus mitigating the cognitive bias inherent to a polled result. However, this patent does not teach or suggest a process that overcomes or accounts for the cognitive biases of a decision making agent that occur when making an objectively optimal choice.

U.S. Pat. No. 6,727,914 to Koninklijke Philips Electronics N.V. discloses a method and apparatus for making television recommendations through the use of decision trees. Not unlike U.S. Pat. No. 5,704,017, this patent uses historical choice preferences of an agent to make recommendations for future viewing decisions. Though this patent suggests a method for predicting an agent's future preference given past preferences, it does not teach or suggest a process that overcomes or accounts for the cognitive biases of a decision making agent that occur when making an objectively optimal choice.

U.S. Pat. No. 6,850,923 to NCR Corporation discloses an expert system and method for providing automated advice that is regularly updated by a plurality of experts within a shared field or domain. The collaborative updating of an expert knowledge base mitigates the knowledge limitations of a single expert, thus providing a more comprehensive level of expertise to any given request. However, this patent does not teach or suggest a process that overcomes or accounts for the cognitive biases of a decision making agent that occur when making an objectively optimal choice.

U.S. Pat. No. 6,980,983 to IBM Corporation discloses a method of collective decision making by iteratively polling a plurality of decision makers to gain cumulative support for a given decision. The collaborative approach, like U.S. Pat. Nos. 5,878,214 and 6,119,149, organizes multiple agents for problem solving and decision making. However, this patent does not teach or suggest a process that overcomes or accounts for the cognitive biases of a decision making agent that occur when making an objectively optimal choice.

U.S. Pat. No. 7,130,836 to XFI Corporation discloses a method and rules-based system that helps evaluate and rank a plurality of choice alternatives related to a purchasing decision. Unlike other prior art references, this patent provides a method that addresses the cognitive problems that occur when evaluating a set of choice alternatives. However, this patent does not teach or suggest a process that overcomes the analytical limitations of a rules-based system when generating choice alternatives from a database of historical choice alternatives nor does it teach or suggest a process that improves the expertise of the rules-based analysis engine.

Therefore, there remains a need for a system and method that overcome the problems and limitations present in prior art teachings. Such a system and method should overcome or account for the cognitive biases of a decision making agent that occur when making an objectively optimal choice. Human decision makers need to obtain objective, alternative choice recommendations that compensate for the biases inherent to cognitive heuristics and that compensate for the analytical limitations present in conventional rules-based systems.

### SUMMARY OF THE INVENTION

A system and method in accordance with the principles of the present invention overcomes the problems and limitations present in prior art teachings. A system and method in accordance with the principles of the present invention overcomes or accounts for the cognitive biases of a decision making agent that occur when making an objectively optimal choice. A system and method in accordance with the principles of the present invention provides human decision makers with objective, alternative choice recommendations that compensate for the biases inherent to cognitive heuristics and that compensate for the analytical limitations present in conventional rules-based systems.

A method and system for optimal choice is described. An inductive database system uses an integration of historical data and virtual data (in the form of intuitive rule-sets specified by an agent or plurality of agents) to make statistical recommendations for optimal choice. Filter mechanisms support the reporting of choice recommendations and user interaction with historical data. In the latter case, user interaction with a deductive interface allows for the testing of decision criteria or rule-sets against an historical database and empirical target results. The constant testing of ideas against an objective function provides an update methodology for a database of virtual data and provides a training methodology for the user. An example of picking stock investments is given.

Other preferred features of the invention will be apparent from the attached claims and the following descriptions.

### BRIEF DESCRIPTION OF THE DRAWINGS

FIG. 1 shows a schematic diagram of a decision making process in accordance with the principles of the present invention.

FIG. 2 shows a flow chart in accordance with an embodiment of the present invention.

FIG. 3 shows a schematic diagram of an embodiment of a system in accordance with the principles of the present invention.

FIG. 4 shows a schematic diagram of an embodiment of memory or storage contents data in accordance with the principles of the present invention.

FIG. 5 shows a schematic diagram of an embodiment of memory or storage contents procedures in accordance with the principles of the present invention.

### DETAILED DESCRIPTION

In summary, a system and method in accordance with the principles of the present invention generates, evaluates, and selects among a set of choice alternatives using an inductive database system comprising the utilization of inductive and deductive filtering mechanisms, the online asynchronous distributed updating of a virtual sample space, and the statistical integration of historical and virtual choice alternatives.

A system and method in accordance with the principles of the present invention provides optimal choice in specific areas of decision making. Areas of application can include, but are not limited to, financial management, fantasy sports, real estate, agriculture, health, government, marketing, and the like.

In a broad sense, an aspect of a system in accordance with the principles of the present invention comprises an inductive database system. A database of historical choice alternatives, an inductive filtering mechanism, a decision making agent, a means for deductively sampling choice alternatives from a single agent or a plurality of agents, a means for the online asynchronous collection of choice alternatives from a single agent or a plurality of agents, a database of virtual choice alternatives, and a means for integrating historical choice alternatives with virtual choice alternatives can be provided. A system in accordance with the principles of the present invention also resides in a decision making method that maintains a database of historical choice alternatives and an inductive database system, samples choice alternatives from an agent or plurality of agents, online asynchronously updates a virtual choice alternatives database, and integrates historical data with virtual data.

When used herein the term “decision maker,” “decision making agent” or “agent” should be understood to comprise any person responsible for selecting from a set of choice alternatives. Examples can include, but are not limited to, a consumer faced with a purchasing decision, a business leader who has to decide what market segment to target or a finance professional who has to decide how to allocate funds across a discrete set of securities. Any method, process or system that facilitates or creates a selection outcome is said to include a “decision maker,” “decision making agent” or “agent.”

When used herein the term “choice alternative” or “alternative” should be understood to comprise any unit of information within a sample space of options, including options unknown to the agent, and the units of information embodied by each option. To make an optimal decision, a judgment is made for each option resulting in an infinitely large sample space of combinations. A choice alternative can be any unit or combination of informational units relevant to the generation, evaluation, and selection of the decision making process.

When used herein the term “historical” in conjunction with the concept of an “alternative” or “choice alternative” should be understood to comprise any unit of empirical information within a sample space of options, including measurable options unknown to the agent, and the units of measurable information embodied by each option. Information that can be measured and recorded for a particular decision application is considered “historical.” The daily closing price of a stock could be an historical choice alternative; however, a decision maker's belief about how a stock should perform is not an historical choice alternative.

When used herein the term “virtual” in conjunction with the concept of an “alternative” or “choice alternative” should be understood to comprise any unit of information within a sample space of beliefs, including units of information embodied by each belief. Information detailing the intuitive expectation, evaluation or sampling from a space of historical alternatives is considered “virtual.” Whereas a database of historical data represents a universe of choice alternatives, a database of virtual data represents a universe of beliefs about the universe of choice alternatives. A virtual choice alternative becomes an historical alternative when it is recorded and mapped to the outcome event of a decision. A decision maker's belief about how a stock or set of stocks should perform is a virtual choice alternative; a record of this belief over time is an historical choice alternative related to purchasing stock.

When used herein the term “expert system” or “knowledge based system” should be generally understood to comprise an interface, a deductive inference engine, and a knowledge base. The task of an expert system is to use a set of rules to analyze information (supplied by an agent) and recommend a course of agent action supplied from a database of expert knowledge. A software wizard, as an interactive computer program that helps an agent solve a problem, constitutes an expert system, for example. In short, the term “expert system” refers to any system that uses deductive logic (or what appears as logical reasoning capabilities) to reach a conclusion from data supplied by an agent and an expert.

When used herein the term “inductive database system” should be generally understood to comprise an interface, statistical inference engine, and a database of historical choice alternatives. Counter to the rule-based reasoning of deductive logic, inductive logic is rooted in probability and assumes the process of reasoning about the future from the past. The use of local economic performance to derive national economic policy is an application of inductive logic, for instance. In short, the term “inductive database system” refers to any system that uses inductive logic (or what appears as probabilistic reasoning capabilities) to reach a conclusion from the data supplied by an agent (or plurality of agents) and a database of historical data.

In a further aspect, a system and method in accordance with the principles of the present invention generates a set of choice alternatives using a database of historical choice alternatives. Historical choice alternatives may physically or symbolically originate from proprietary or public sources. Historical choice alternatives, for example, may originate from public websites, proprietary systems or paid data vendors. Historical choice alternatives may also exist through the organization of symbolic representations to specific data sources. Information search and its linking to public web sites is an example of the latter. The generation of choice alternatives from a database of historical data provides an efficient, scientific, objective basis for choosing which choice alternatives are relevant for evaluation. This helps overcome the traditional biases that result when using a cognitive heuristic to generate a set of choice alternatives.

In an additional aspect, a system and method in accordance with the principles of the present invention evaluates and selects among a set of choice alternatives using an inductive filtering mechanism. Statistical methods can be used to data mine and calculate the reliability of historical choice alternatives as a predictor of the objective function being optimized. This process satisfies a number of requirements for a process of optimal choice.

Human agents are shown to prefer singular data over distributional data (Kahneman, D., & Tversky, A. “On the psychology of prediction.” Psychological Review, 80, 237-251 (1973); Kahneman, D., & Tversky, A. “Intuitive prediction: Biases and corrective procedures.” TIMS Studies in Management Science, 12, 313-327 (1979); Tversky, A., & Kahneman, D. (1982). “On the study of statistical intuitions.” Cognition, 11, 123-141 (1982)). An inductive filtering mechanism is able meet this preference by integrating thousands of data points into a single metric. A choice alternative to “Buy” a stock, for example, is more agreeable to an investor then viewing all the raw data motivating the recommendation.

Human agents tend to ignore the base rates inherent to most decision tasks (Tversky & Kahneman (1982); Lichtenstein, S., Fischhoff, B., & Phillips, L. D. “Calibration of probabilities: The state of the art” in H. Jungerman & G. deZeeuw (Eds.), Decision making and change human affairs. Amsterdam: D. Reidel (1977)). An investor's cognitive heuristic used to generate and evaluate a set of choice alternatives, for instance, may have a 0.01 probability for yielding a high investment return. Instead of choosing randomly from an overall market having a base rate of 0.03, the investor will ignore the base rate difference and opt to select from his or her set of choice alternatives. By working through all combinations of historical choice alternatives against the objective function at hand, an inductive filtering mechanism, on the other hand, is able to provide a set of relevant choice alternatives with a substantially improved base rate. For example, an inductive filtering mechanism could provide a set of 10 stock alternatives for the investor with a 0.36 probability of success, regardless of his or her heuristic.

Research on decision making also makes a distinction between experts and novices. In specific, experts tend to have more efficient cognitive heuristics than do novices (Medin, D. L., Ross, B. H., & Markman, A. B. Cognitive Psychology: Fourth Edition. John Wiley & Sons (2005)). The improved representation results from extended practice and experience with a task. Traditional expert systems attempt to provide artificial intelligence to an agent without the time constraint of practice and experience. These systems, however, depend on multiple instances of agent input that are inherently limited to cognitive heuristics. Using computational statistics and other methods known in the art, an inductive filtering system, on the other hand, can learn about more data and data's historical relationship to an objective function at a faster rate than a human expert. Moreover, inductive methods do not require agent input. As a result, inductive filtering provides the relevant knowledge of a “trained expert” without the bias of agent input.

Human agents can hold only a limited number of items in memory at a given time (Miller, G. A. “The magical number seven plus or minus two: Some limits on our capacity for processing information.” Psychological Review, 63, 81-971956)). Based on statistical methods known in the art, an inductive filtering system can provide a ranking system for choice alternatives as the choice alternatives relate to the objective function at hand. This provides the functionality to limit presentation to only the top-ranked choice alternatives. A preferred inductive filtering system provides a method of presentation suitable to the cognitive limitations of a human agent.

Thus, an inductive filtering mechanism in accordance with the principles of the present invention addresses the knowledge limitations of an agent. The preference for singular data, the disregard for base rates, and the need for improved memory representations are met or overcome through an inductive filtering mechanism of the present invention.

In a further aspect, a method and system in accordance with the principles of the present invention evaluates and selects among a set of choice alternatives using a deductive filtering mechanism. Deductive methods using a graphical user interface can be used to interface an agent with a database of historical choice alternatives. This process improves or corrects a decision maker's cognitive biases, a useful component to a process of optimal choice.

Research on how to debias a cognitive heuristic suggests a process of training and feedback (Kahneman & Tversky (1979); Fischhoff, B. “Debiasing” in D. Kahneman, P. Slovic & A. Tversky (Eds.), Judgment under uncertainty: Heuristics and biases. Cambridge University Press, (1982); Nisbett, R. E., Krantz, D. H., Jepson, C., & Fong, G. T. “Improving inductive inference” in D. Kahneman, P. Slovic & A. Tversky (Eds.), Judgment under uncertainty: Heuristics and biases. Cambridge University Press (1982); Cox, D. R. “Two further applications of a model for binary regression.” Biometrica, 45, 562-565 (1958); Savage, L. J. “Elicitation of personal probabilities and expectations.” Journal of the American Statistical Association, 66, (336), 783-801 (1971); Tversky, A., & Kahneman, D. “Judgment under uncertainty: Heuristics and biases.” Science, 185, 1124-1131 (1974); Von Winterfeldt, D., & Edwards, W. Flat maxima in linear optimization models (Tech. Rep. 011313-4-T). Ann Arbor: University of Michigan, Engineering Psychology Laboratory (1973)). An iterative process pairing choice alternatives and their outcome results through a deductive filtering mechanism can improve an agent's memory representation of a decision task, improve an agent's knowledge about a decision task, and improve an agent's intuitive calibration of outcome probabilities.

In one aspect, a method and system in accordance with the principles of the present invention can improve an agent's memory representation of a decision task. A preferred deductive filtering mechanism of the present invention presents choice alternatives, along with their outcome results, in an interactive, graphical format. The repetitive interaction with a database of choice alternatives and the immediate feedback of outcome results enables the agent to redefine his or her memory representation of the decision problem. A stock screen, for example, is a common tool for identifying a set of stock alternatives from a database of historical choice alternatives. Providing and saving empirical estimates for each screen gives the agent a mechanism to improve the serial processing of his or her decision and validate the empirical validity of his or her cognitive heuristic. The decision task that starts with deductive criteria A (e.g., value stocks: count=512, monthly return=1.5%) and ends with deductive criteria Z (e.g., value stocks priced between $10 and $12: count=22, monthly return=5.6%) demonstrates a controlled mapping of one memory representation to another with an improvement in the outcome result. The agent's new memory representation of choice alternatives (e.g., criteria Z) is more efficient (e.g., count=22) and optimally better (e.g., return=5.6%).

In another aspect, a method and system in accordance with the principles of the present invention can improve an agent's knowledge about a decision task. To improve the memory representation of a decision problem, it is often necessary to elicit information from an agent that he or she would normally neglect (Kahneman & Tversky (1979)). The repetitive interaction with a database of choice alternatives and the immediate feedback of outcome results requires the agent to think beyond his or her current heuristic. A poor heuristic, like a stock screen with a −1.1% return, for example, requires amendment if the objective is maximization. The deductive filtering mechanism prompts the agent to think about additional choice alternatives, the greater context in which the alternatives exist or possibly to completely redefine the decision problem altogether (e.g., short-trading stocks versus a buy-and-hold approach). By eliciting information from the agent, his or her higher-level memory structures can be challenged and refined (Kahneman & Tversky (1979)).

In another aspect, a method and system in accordance with the principles of the present invention can improve an agent's intuitive calibration of outcome probabilities. A preferred deductive filtering mechanism of the present invention will pair choice alternatives and their outcome results in a risk-free manner to augment the calibration activity of an agent. Weather forecasters, for example, are considered one of the most well calibrated professionals because they work on a repetitive task (e.g., will it rain?) with a well defined and prompt outcome result (Lichtenstein, Fischhoff & Phillips (1977)). Likewise, a stock screen is a deductive mechanism that repetitively pairs choice alternatives with an empirical outcome result. The iterative process of generating and empirically evaluating choice alternatives through a deductive filtering mechanism improves the intuitive probabilities of an agent.

Thus, a deductive filtering mechanism in accordance with the principles of the present invention helps correct the cognitive biases of an agent. The need to consider different problem representations, to consider new knowledge, and to increase the calibration activity for a decision problem can be met through a deductive filtering mechanism of the present invention.

In a further aspect, a method and system in accordance with the principles of the present invention generates and stores a set of choice alternatives using a proprietary database of virtual choice alternatives. Virtual choice alternatives originate from the deductive filtering mechanism. An agent's sampling of an historical choice alternative and its empirical estimates can be saved in computer memory or on disk. A single sample or an aggregation of multiple samples across a single agent or a plurality of agents, or any combination thereof, constitutes a database of virtual choice alternatives. The generation of choice alternatives from a database of virtual choice alternatives provides a method for mitigating memory and processing limitations of a single agent and for overcoming efficiencies that occur in a system of multiple agents.

In one aspect, a method and system in accordance with the principles of the present invention calculates the intuitive expectation of performance for a deductive memory representation. Research has shown that expected gain is a function of an agent's subjective probability rather than real world action and result (Von Winderfeldt & Edwards (1973)). This implies that asking people for the expected performance of a decision will yield biased information. When tracked over time and across multiple samples or across a plurality of agents or both, however, a database of virtual choice alternatives becomes a database of historical choice alternatives. Model fitting procedures applied to a history of virtual choice alternatives is an appropriate debiasing method (Cox (1958)) and provides a corrected mapping of virtual choice alternatives to outcome results. A stock trader or a plurality of stock traders, for example, may begin sampling historical choice alternatives with a stock screen criteria characteristic of value stocks. By using a database of virtual choice alternatives, the sampling of intuitive expectations can be reliably mapped to future outcomes through statistical or mathematical procedures. For example, by showing an increased use of value stock criteria, stock traders may anticipate a trend reversal favoring value stocks; a model fitting exercise may confirm that, indeed, intuitive expectation reliably predicts a trend reversal x days before its empirical manifestation. Because intuitive expectations reflect an integrated forecast for future performance of a decision, it is important to include them in a process of optimal choice. A controlled mapping of virtual choice alternatives to their empirical outcomes mitigates the memory and processing limitations inherent to subjective probability biases.

In another aspect, a method and system in accordance with the principles of the present invention helps overcome efficiencies that occur in a system of multiple agents. In a system where a plurality of agents work in a disjoint manner against a common goal, it is possible that the shared use of information, like a public database of historical choice alternatives, removes any advantage that may exist. A proprietary database of virtual choice alternatives, however, removes the possibility of such market efficiencies since it is non-transparent to an agent. An agent's history of memory representations and empirical results are available through the deductive filtering mechanism, but the corrective mapping of intuitive expectation to its outcome result is not. A database of virtual choice alternatives for an agent or plurality of agents provides the virtual expectation about the performance of a system (like the U.S. stock market as measured by the performance of the Dow Jones Industrial Average index promulgated by the Dow Jones & Company, Inc., One World Financial Center, 200 Liberty Street, New York, N.Y. 10281).

In a further aspect, a method and system in accordance with the principles of the present invention integrates a database of historical choice alternatives with a database of virtual choice alternatives. A preferred method of integration uses Bayes' formula, P(A|B)=P(A∩B)/P(B), in its statistical estimation. Bayes' formula is a statistical method for integrating prior belief (virtual data) with empirical evidence (historical data) according to the universal laws of probability. The integration of virtual and historical choice alternatives provides a method for deriving expertise from empirical data and individual knowledge in a reliable and efficient manner.

In one aspect, the integration of a database of historical choice alternatives with a database of virtual choice alternatives of the present invention provides a method for deriving expertise from empirical data and individual knowledge. Consider the formal expression of Bayes' Theorem,

$$p ( θ \vert y , η ) = \frac{f ( y \vert θ ) π ( θ \vert η )}{\int f ( y \vert u ) π ( u \vert η ) d u}$$

where y is a vector of historical data, θ a vector of unknown parameters for a given model, and η a vector of hyperparameters. The goal of statistical exercise is to arrive at an estimate for each parameter in θ. According to Bayes' Theorem, prior knowledge or subjective belief is integrated through the term π(θ/η). The final combination of empirical data, f(y|θ), and virtual data, π(θ/η), creates a finite sampling distribution, p(θ|y,η), for θ that allows for unique statements about the objective function at hand. This embodiment is contrasted with decision methods related to expert systems (that reference a deductive knowledge base), polling procedures (that use individual opinion) or common statistical approaches (that use strictly empirical data for estimation purposes).

In a further aspect, the integration of a database of historical choice alternatives with a database of virtual choice alternatives of the present invention provides a method for deriving expertise from empirical data and individual knowledge in an efficient manner. Unlike expert systems and polling procedures that may often require extensive human intervention, or common statistical approaches that must avoid intractable models, the integration of historical and virtual choice alternatives of the present invention can be done computationally without limitation to its underlying model. For example, the calculus in the denominator of the formal expression of Bayes' Theorem, traditionally an analytical impossibility, can be solved computationally, thus mitigating the limitations for the statistical model. Moreover, the simulation routines of Bayes' Theorem can be run on a single computer processor or a plurality of computer processors run in parallel. The efficiency of integrating historical and virtual choice alternatives provides extensive learning and, thus, the updated expertise needed for a process of optimal choice.

In a further aspect, the integration of a database of historical choice alternatives with a database of virtual choice alternatives of the present invention provides a method for deriving expertise from empirical data and individual knowledge in a more reliable manner. Bayes' Theorem and the computational methods for solving its application follow the universal laws of probability. Final estimation of parameters or the objective function or both follows a level of internal reliability.

The following is a non-limiting Example of a method and system for optimal choice in accordance with the principles of the present invention.

### EXAMPLE

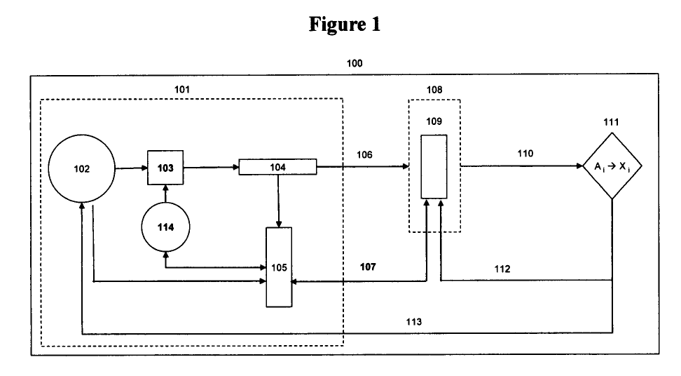

FIG. 1 shows a schematic diagram of a decision making process in accordance with the principles of the present invention. The system 100 of FIG. 1 can include an inductive database system 101 linked to a human decision making agent 108 through a reporting interface 106. The decision making agent 108 comprises a heuristic 109 for generating, evaluating, and selecting from a set of choice alternatives. When a decision making agent 108 selects among a set of alternatives, thus making a decision 110, his or her decision output can be mapped as an action to a result 111. The mapping of action to result 111 can be fed back 112 to the decision making agent 108, who may use the feedback to update, confirm or correct the heuristic 109 used to make the original decision. The general concept of training and feedback used for calibrating human judgment can be viewed as an iterative process of a decision making agent 108 making a decision 110, subsequent action and result 111, feedback 112, and the updating of the heuristic 109 followed by another decision 110. In real-world situations, the result 111 is empirical and can be recorded in an inductive database system 101.

The decision making agent 108 may interact with the inductive database system 101 via a wide area network such as the Internet utilizing a World Wide Web (WWW) or network browser. The filtering mechanisms of the inductive database system 101 can reside at a web server, and an application server allows the decision making agent 108 to interact online. The decision making agent 108 can interact with the inductive database system 101 through two methods: a unidirectional method 106 where database information can be published to a web browser for review and linking to other web pages, and a bidirectional method 107, where database information can be coupled to a decision making agent's interaction with published content. The inductive database system 101 may operate in a generic sense in that the inputs and outputs of the inductive database system 101 can be customized for a particular situation or application. This can be accomplished through Standard Query Language (SQL) used to retrieve information from a relational database. Placing external constraints on SQL criteria defines the type of information to be used by a specific agent or decision making application.

The real world decision of a decision making agent 108 produces a mapping between action and result 111. For the present invention, the mapping provides a definition for empirical optimization. Some common definitions can include, but are not limited to, profit, loss, speed, performance, time, and the like. The empirical result for a given decision is an important component of the present invention since it is a unit of public or proprietary information that can be used to update an inductive database system 101.

FIG. 1 also shows an inductive database system 101 comprising a database of historical choice alternatives 102 linked to a method for integrating historical and virtual choice alternatives 103. The method for integrating historical and virtual choice alternatives 103 can be linked to an inductive filtering mechanism 104. The inductive filtering mechanism 104 can be linked to a deductive filtering mechanism 105 and to a decision making agent 108 through a unidirectional interface 106.

The methods for storing historical choice alternatives in a database may follow practices and technologies known in the art. Generally, each application can have its own proprietary or enterprise method for extracting, transforming, and loading choice alternatives into a scaleable information warehouse environment. In special cases, the database can also have metrics created from proprietary data, or can constitute the organization of symbolic references to non-proprietary data, or both. The retrieval of information from a database of choice alternatives may also follow practices known in the art.

The method for integrating historical and virtual choice alternatives 103 can follow Bayes' Rule for integrating prior knowledge with historical data according to a given statistical model. A Bayesian approach to data integration provides distinct advantages. A Bayesian formula allows for the dynamic training and updating of expertise. Virtual choice alternatives can be computationally weighted to provide a controlled balance between what has happened and what an agent or plurality of agents expect will happen. Conventional approaches like expert systems, opinion polls, and non-Bayesian statistics require extensive human intervention to maintain the knowledge relevant to a decision task.

In addition, Bayesian methods are efficient. Their computational methods can solve intractable calculus on a single computer processor or a plurality of processors run in parallel. The step taken to extract, transform, and stage data for Bayesian application may follow a process or method known in the art. The statistical model within the Bayesian application may follow a form such as linear, logistic or nonlinear regression techniques, for example.

The inductive filtering mechanism 104 can be a web server program or application that retrieves database information for publication according to the cognitive preferences of an agent. The deductive filtering mechanism 105 can be a web server program or application that collects deductive logic from an agent, retrieves database information according to the deductive logic, and writes the deductive logic and a summary about its database query results to an alternate database. The preferred filtering mechanisms can be written in a known computer programming language and can utilize SQL when interacting with the relational database systems.

The inductive filtering mechanism 104 publishes an integration of historical and virtual data. The inductive filtering mechanism 104 limits the computational complexity of a decision problem by generating a small list of choice alternatives according to how well they optimize the objective function at hand. The Bayesian methods inherent to the data integration, for example, provide an empirical rank or score that can be used to order the choice alternatives by likelihood to optimize future choice outcomes. The inductive filtering mechanism presents a small set of top ranking alternatives according to a generic criteria set by the system administrator (e.g., no more than 10) or by the agent through the deductive filtering mechanism (e.g., alternatives with attribute Q). The preferred inductive filtering mechanism of the present invention will specifically present a limited set of singular data with an improved base rate for success.

FIG. 1 also shows an inductive database system 101 comprising a database of historical choice alternatives 102 linked to a deductive filtering mechanism 105 which can be coupled to an agent 108. The decision making agent 108 can interact directly with historical data and inductive filtering output through the deductive filtering mechanism 105. The data from the database of historical choice alternatives 102 provides a conditionally exhaustive set of choice alternatives that can be queried through the deductive filtering mechanism 105. This configuration helps overcome memory limitations of the decision making agent 108 by providing a rules-based interface that complements the form of human logic and that maps the historical performance of a rule set to an historical outcome result. The output from the inductive filtering mechanism 104 represents objective, data-driven choice recommendations for the optimal mapping of action to result 111. This helps overcome the knowledge limitations of the decision making agent 108 by extracting relevant knowledge through extensive statistical learning of the data and delivering it according to the deductive, cognitive preferences of the agent. The coupling of the deductive filtering mechanism 105 and the decision making agent 108 through an interface 107 mimics the real world training of a decision 110, its action and result 111, subsequent feedback 112, and correction of its heuristic 109. This mimic provides an efficient method for an agent to repetitively test intuition against statistical learning and historical data without real world consequences.

FIG. 1 also shows an inductive database system 101 comprising a database of historical choice alternatives 102 linked to a deductive filtering mechanism 105. The deductive filtering mechanism 105 can be coupled to a database of virtual choice alternatives 114 which can be linked to a method for integrating historical and virtual choice alternatives 103. A decision making agent 108 applies intuition to a decision task by evaluating inductive filtering output against historical data through a deductive filtering mechanism 105. The deductive logic specified by a decision making agent 108 can be a symbolic manifestation of his or her heuristic and can be saved in a database of virtual choice alternatives 114. Deductive logic used in the past can be presented to the decision making agent 108 through the deductive interface 107 as a means for training and feedback of a memory representation. The database of virtual choice alternatives 114 can be linked to a method for integrating historical and virtual choice alternatives 103.

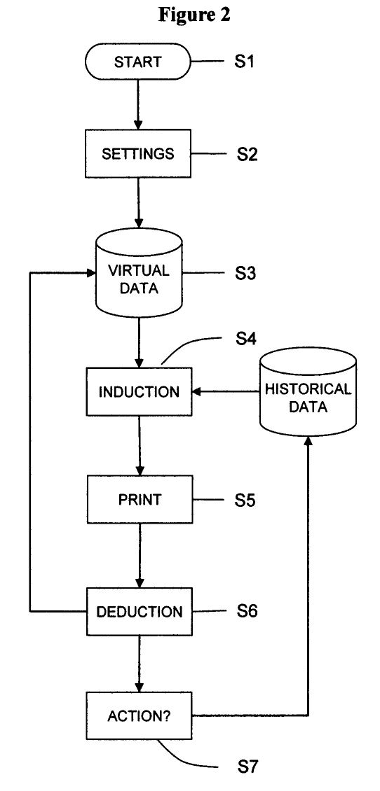

FIG. 2 shows a flow chart in accordance with an embodiment of the present invention. A decision making agent begins at S1 by accessing the online web server application through for example a World Wide Web (WWW) or network browser. A global rule-set (if it is a first time visit) or a previously derived rule-set (if it is a repeat visit) is written to memory at S2. The logical rule sets can be of the form that can be combined and used within the “where clause” of a Standard Query Logic (SQL) statement. In general, this involves a comparative statement using inequalities (e.g., X<A or B=Z) or a statement using search (e.g., X in list L or X like “abc”). The units of information in each rule-set represent distinct attributes about a set of historical choice alternatives. When consensus is reached on what rule-set to use, it is set as the default rule-set and the process proceeds to step S3.

At this stage, an agent's chosen rule-set and its updated performance metrics can be stored. The server where rule-sets are written can be referred to as a database of virtual choice alternatives. Since a logical rule-set represents the symbolic heuristic of an agent, it is important to track changes to its definition and the performance of its metric variables. Tracking and reporting rule-set changes and their performance over time gives a single decision making agent the control he or she needs to systematically evaluate his or her heuristic. Data mining rule-set changes and their performance over time, across a plurality of agents, leads to improved prediction of future objective function behavior. Indeed, large scale sampling of intuitive expectations, as defined by a plurality of rule-sets, provides a robust method for defining what a community thinks is “the next big thing” within a set of choice alternatives.

At S4, the decision making agent can be presented a reporting page that provides combinations of choice alternative information, such as for example: the default rule-set definition; the default rule-set performance; a set of choice alternatives recommended by statistical means; a set of choice alternatives recommended by non-statistical means; message alerts; raw data; descriptive information about a choice alternative or a set of alternatives; and links to alternative sources of information related to a specific choice alternative or set of choice alternatives. A cogent form of presentation can include just the default rule-set definition, the default rule-set performance, and a set of choice alternatives recommended by statistical means. It is possible that the decision making agent will have a rule-set so limited that available statistical recommendations can be filtered out. The deductive methods discussed below can readily cope with this possibility. Another possibility is that a rule-set is so broad that all available statistical recommendations are included by its definition. This possibility can be managed by having the system administrator set an external constraint limiting the number of recommendations to no more than 5-10 choice alternatives, for example. In summary, the statistical recommendations reduce the computational complexity of the decision problem by providing a small list of alternatives with the knowledge (statistical training) to improve the odds for optimal choice. Starting with the recommendations, further research proceeds by linking to other page sources publishing alternative choice information.

At S5, the decision making agent has the option to print a given reporting page to an input/output (I/O) device such as a printer or other such I/O devices known in the art. In a cogent form, a reporting page can serve as a reminder of past performance, of the default rule-set, and as a directive for how further research may proceed for a limited set of recommended choice alternatives

At S6, the decision making agent can interface with a database of historical choice alternatives through a deductive filtering mechanism. The deductive filtering mechanism lets the agent edit or create a rule set by selecting a choice alternative attribute and making an intuitive statement about its value (e.g., attribute A<X or attribute C=‘yes’). A single rule or combination of rules constitutes a rule-set. After a rule-set is defined, the deductive filtering mechanism calculates its historical performance against the objective function at hand, writes the rule-set definition and performance metrics to a database of virtual choice alternatives, and publishes the results to a reporting page. Multiple results can be printed to the reporting page in chronological order so an agent can track the evolution of a rule-set and its related performance over time. Tracking and evaluating multiple rule-set over time is an important activity for restructuring the heuristic. Unlike real world experience, repetitive deductive activity, benchmarked against the historical performance of the objective function, allows an agent to improve his or her heuristic without cost (e.g., no loss of money, time, life, or performance).

At S6, the decision making agent can also manage a set of rule-sets. This includes naming, editing, re-writing, and deleting rule-sets published on the reporting page. Rule-sets can be written to a database in S3 as they are created or edited. A reporting page, however, does not publish a deleted rule-set. Once an agent decides to make a real world decision, an action can be made and the process proceeds to S7.

At this stage, a decision has been made and an empirical choice result exists. The empirical nature of the result may occur in a private (e.g., a decision made at work) or public (e.g., a decision to buy stock in a company) domain. The defining attribute of a choice result is that it is measurable and recordable. In most cases, choice results will be written to a database and known methods can be used to populate the database of historical choice alternatives embodied by the present invention. When a choice result has been updated in the database of historical choice alternatives, the choice result is returned to S4 as a unit of information within the integration of virtual and historical choice alternatives.

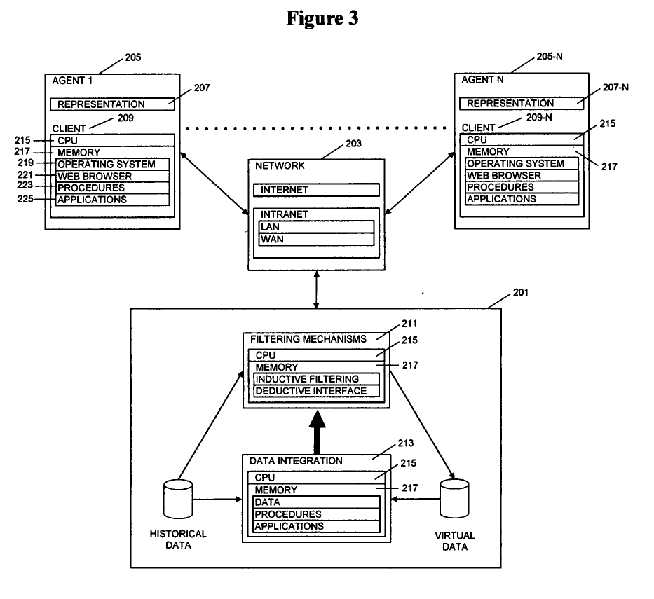

FIG. 3 shows a schematic diagram of an embodiment for implementing an inductive database system for optimal choice in accordance with the principles of the present invention. In this embodiment, an inductive database system 201 can be coupled to a network 203 in a conventional manner. Decision making agents 205 comprising a heuristic 207 may also connect to the inductive database server 201 from a client computer 209 via a network connection 203.

In one embodiment, the inductive database system 201 can provide a set of web servers connected to databases that run: the ETL (extraction, transform, and load) software needed for maintaining a database of historical choice alternatives; the statistical software for integrating historical and virtual data; the procedures and software that run the inductive and deductive filtering mechanisms; the reporting tools needed for publishing results; the ETL software needed for maintaining a database of virtual choice alternatives; and operating systems and other software upon which the above software might rely.

Each inductive database system server 211, 213 and each agent client computer 209 can be of conventional type having a processor or CPU 215, memory 217 coupled with the processor or CPU 215, and possibly various input/output devices known in the art. It will also be appreciated that although two inductive database system servers are shown, multiple servers may conveniently be provided for additional capacity or redundancy, and such may be collocated or geographically dispersed.

Each agent client computer 209 may also store data and procedures in the form of computer software programs. In general, such agent machine 209 can provide: an operating system 219; a web browser or other network browser 221; procedures 223 for receiving, publishing or storing data locally; and applications 225 necessary for interacting with an inductive database system 201.

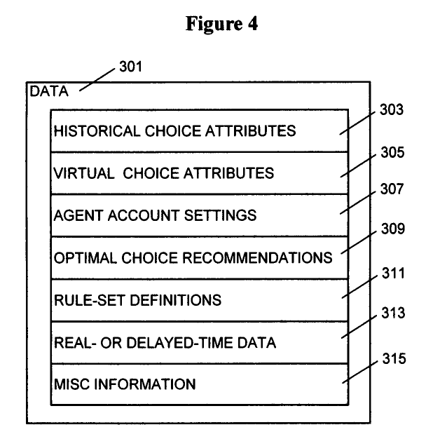

FIG. 4 shows a schematic diagram of an embodiment of memory or storage contents data in accordance with the principles of the present invention. Data components 301 may include for example: historical choice attributes 303 for publishing historical performance; virtual choice attributes 305 for filtering recommendations according to a pre-defined rule-set; agent account settings 307 for filtering recommendations according to certain preferences; optimal choice recommendations 309 for minimizing computational complexity of a decision task; rule-set definitions 311 for editing and deleting rule-sets within the deductive filtering mechanism; real- or delayed-time data 313 for reporting purposes when appropriate; and other miscellaneous data 315 needed to support one of the features of the present invention.

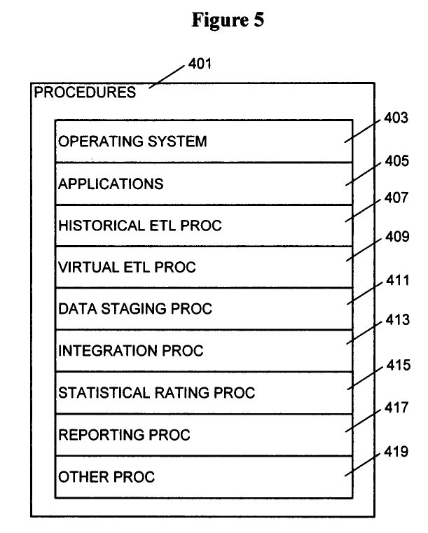

FIG. 5 shows a schematic diagram of an embodiment of memory or storage contents procedures in accordance with the principles of the present invention. Procedures 401 implemented in computer program software, firmware or other means may include for example: an operating system 403; various application programs 405; historical extract; transform and load (ETL) procedures 407; virtual ETL procedures 409; a data staging procedure 411 for prepping input to the integration procedure 413; a statistical rating procedure 415; a reporting procedure 417; and other procedures 419 as may be desired or required to implement particular features or capabilities of the inductive database system and method.

While the invention has been described with specific embodiments, other alternatives, modifications and variations will be apparent to those skilled in the art. For example, while in the preferred embodiments described herein the financial instruments were stocks, the principles of the present invention are not so limited but rather apply to any traded financial instrument and indeed, certain aspects of the present invention can be applied outside the financial applications. Accordingly, it will be intended to include all such alternatives, modifications, and variations set forth within the spirit and scope of the appended claims.

What is claimed is:

1. A system for optimal choice comprising:
creating a database of historical data;
creating a database of virtual data;
integrating the historical data and the virtual data;
inductively filtering the integrated historical data and virtual data to make statistical recommendations for optimal choice;
testing the statistical recommendations for optimal choice by deductively filtering against the database of historical data; and
updating the database of virtual data as a result of the testing.

2. The system for optimal choice of claim 1 further including testing the statistical recommendations for optimal choice by deductively filtering against the database of historical data and empirical target results.

3. The system for optimal choice of claim 1 further wherein creating a database of virtual data comprises at least one agent specifying at least one rule-set.

4. The system for optimal choice of claim 3 further including creating at least one rule-set by selecting a choice alternative attribute and making an intuitive statement about its value.

4. The system for optimal choice of claim 1 further including online asynchronous updating the database of virtual data as a result of the testing.

5. The system for optimal choice of claim 1 further wherein inductively filtering the integrated historical data and virtual data comprises presenting a limited set of choice alternatives.

6. The system for optimal choice of claim 1 further wherein inductively filtering the integrated historical data and virtual data comprises generating a discrete number of choice alternatives according to how well the choice alternatives optimize future choice outcomes.

7. The system for optimal choice of claim 6 further wherein generating a discrete number of choice alternatives comprises providing an empirical score to order the choice alternatives by likelihood to optimize future choice outcomes.

8. The system for optimal choice of claim 1 further including maintaining a database of historical data selected from the group comprising proprietary sources, public sources, and combinations thereof.

9. The system for optimal choice of claim 1 further including integrating historical data with virtual data utilizing Bayesian methods.

10. The system for optimal choice of claim 9 further including integrating historical data with virtual data in accordance with:
$$p ( θ \vert y , η ) = \frac{f ( y \vert θ ) π ( θ \vert η )}{\int f ( y \vert u ) π ( u \vert η ) d u}$$
where y is a vector of historical data, θ a vector of unknown parameters for a given model, and η is a vector of hyperparameters.

11. The system for optimal choice of claim 1 further wherein, when tracked over time and across multiple samples, the database of virtual data becoming a database of historical data.

12. The system for optimal choice of claim 1 further wherein, using the database of virtual data, mapping a sampling of intuitive expectations to future outcomes.

13. The system for optimal choice of claim 1 further including selecting the area of decision making from the group comprising financial management, fantasy sports, real estate, agriculture, health, government, marketing, and the like.

14. A system for generating and evaluating among a set of choice alternatives comprising:
creating a database of historical choice alternatives;
creating a database of virtual choice alternatives of intuitive rule-sets specified by at least one agent;
integrating the historical choice alternatives and the virtual choice alternatives; and
inductively filtering the integrated historical choice alternatives and virtual choice alternatives for optimal choice.

15. The system for generating and evaluating among a set of choice alternatives of claim 14 further including testing the statistical recommendations for optimal choice by deductively filtering against the database of historical data.

16. The system for generating and evaluating among a set of choice alternatives of claim 14 further including testing the statistical recommendations for optimal choice by deductively filtering against the database of historical data and empirical target results.

17. The system for generating and evaluating among a set of choice alternatives of claim 14 further wherein creating a database of virtual data comprises at least one agent specifying at least one rule-set.

18. The system for generating and evaluating among a set of choice alternatives of claim 17 further including creating at least one rule-set by selecting a choice alternative attribute and making an intuitive statement about its value.

19. The system for generating and evaluating among a set of choice alternatives of claim 14 further including online asynchronous updating of a database of virtual data as a result of the testing.

20. The system for generating and evaluating among a set of choice alternatives of claim 14 further wherein inductively filtering the integrated historical choice alternatives and virtual choice alternatives comprises presenting a limited set of choice alternatives.

21. The system for generating and evaluating among a set of choice alternatives of claim 14 further wherein inductively filtering the integrated historical choice alternatives and virtual choice alternatives comprises generating a discrete number of choice alternatives according to how well the choice alternatives optimize future choice outcomes.

22. The system for generating and evaluating among a set of choice alternatives of claim 21 further wherein generating a discrete number of choice alternatives comprises providing an empirical score to order the choice alternatives by likelihood to optimize future choice outcomes.

23. The system for generating and evaluating among a set of choice alternatives of claim 14 further including creating a database of historical choice alternatives selected from the group comprising proprietary sources, public sources, and combinations thereof.

24. The system for generating and evaluating among a set of choice alternatives of claim 14 further including integrating historical choice alternatives with virtual choice alternatives utilizing Bayesian methods.

25. The system for generating and evaluating among a set of choice alternatives of claim 24 further including integrating historical choice alternatives with virtual choice alternatives in accordance with:
$$p ( θ \vert y , η ) = \frac{f ( y \vert θ ) π ( θ \vert η )}{\int f ( y \vert u ) π ( u \vert η ) d u}$$
where y is a vector of historical data, θ a vector of unknown parameters for a given model, and η is a vector of hyperparameters.

26. The system for generating and evaluating among a set of choice alternatives of claim 14 further wherein, when tracked over time and across multiple samples, the database of virtual choice alternatives becoming a database of historical choice alternatives.

27. The system for generating and evaluating among a set of choice alternatives of claim 14 further wherein, using the database of virtual choice alternatives, mapping a sampling of intuitive expectations to future outcomes.

28. The system for generating and evaluating among a set of choice alternatives of claim 14 further including selecting the area of decision making from the group comprising financial management, fantasy sports, real estate, agriculture, health, government, marketing, and the like.

29. An inductive database system for optimal choice in decision making comprising:
a database of historical choice alternatives;
a database of virtual choice alternatives of rule-sets specified by at least one agent;
the database of historical choice alternatives and the database of virtual choice alternatives being statistically integrated; and
the integrated historical choice alternatives and virtual choice alternatives being inductively filtered to present choice alternatives.

30. The inductive database system of claim 29 further wherein the statistical recommendations for optimal choice are tested against the database of historical data by deductive filtering.

31. The inductive database system of claim 29 further wherein the rule-sets comprise a choice alternative attribute and an intuitive statement about the choice alternative attribute value.

32. The inductive database system of claim 29 further wherein inductively filtering the integrated historical choice alternatives and virtual choice alternatives comprises presenting a limited set of choice alternatives.

33. The inductive database system of claim 29 further wherein a discrete number of choice alternatives are generated according to how well the choice alternatives optimize future choice outcomes.

34. The inductive database system of claim 33 further wherein an empirical score is provided to order the choice alternatives by likelihood to optimize future choice outcomes.

35. The inductive database system of claim 29 further wherein the database of historical choice alternatives is created from the group comprising proprietary sources, public sources, and combinations thereof.

36. The inductive database system of claim 29 further wherein the historical choice alternatives are integrated with the virtual choice alternatives utilizing Bayesian methods.

37. The inductive database system of claim 36 further wherein the historical choice alternatives are integrated with the virtual choice alternatives in accordance with:
$$p ( θ \vert y , η ) = \frac{f ( y \vert θ ) π ( θ \vert η )}{\int f ( y \vert u ) π ( u \vert η ) d u}$$
where y is a vector of historical data, θ a vector of unknown parameters for a given model, and η is a vector of hyperparameters.

38. The inductive database system of claim 29 further wherein, when tracked over time and across multiple samples, the database of virtual choice alternatives becomes a database of historical choice alternatives.

39. The inductive database system of claim 29 further wherein a sampling of intuitive expectations to future outcomes is mapped using the database of virtual choice alternatives.

40. The inductive database system of claim 29 further wherein the area of decision making is selected from the group comprising financial management, fantasy sports, real estate, agriculture, health, government, marketing, and the like.
